(19) United States
(12) Patent Application Publication
(10) Pub. No.: US 2014/0061078 A1
(43) Pub. Date: Mar. 6, 2014

(54) SYSTEMS AND APPARATUS FOR PORTFOLIO EXPANSION

(71) Applicant: Boris M. Ratliff, Paradise Valley, AZ (US)

(72) Inventor: Boris M. Ratliff, Paradise Valley, AZ (US)

(21) Appl. No.: 14/016,019

(22) Filed: Aug. 30, 2013

Related U.S. Application Data
(60) Provisional application No. 61/695,883, filed on Aug. 31, 2012.

(51) Int. Cl. B42F 7/08

(52) U.S. Cl. CPC B42F 7/08
USPC 206/425

(57) ABSTRACT

Systems and methods for portfolio expansion according to various aspects of the present invention may comprise an insert portion configured for coupling a portfolio expansion system to an internal pocket of one or more organization systems, a folder portion configured for storage and organization of various items, a pad attachment system for coupling various external components, and a storage space configured for storage and organization of various items. The portfolio expansion system may be adapted to substantially easily attach and detach to and from the organization systems

### CROSS-REFERENCES TO RELATED APPLICATIONS

This application claims the benefit of U.S. Provisional Application No. 61/695,883, filed Aug. 31, 2012, and incorporates the disclosure of such application in its entirety by reference. To the extent that the present disclosure conflicts with any referenced application, however, the present disclosure is to be given priority.

### BACKGROUND OF THE INVENTION

Document organization systems such as file folders, portfolios, padfolios, and brief cases for storing and transporting documents provide features such as integrated pockets, sleeves, access for note pads, ring-binders, and the like. However, incorporation of these features into a single organizational system may increase the size and thickness of the organizational system without maximizing the expanded organizational and storage capacity. Further, systems such as a portable portfolio may have a limited number of storage options. For example, padfolios often come in the form of as portable carrier that opens like a book to provide an interior space having a writing pad disposed along as right hand side of the interior space, a section for storing documents along a left hand side of the interior, and several additional pockets and sleeves for storing writing instrument, business cards, and other similar relatively small items that may needed by the user. These features are generally permanently integrated into the organization system thereby preventing removal from the padfolio. As a result, the storage capacity and inherent usefulness of a padfolio is somewhat limited since there is no inherent ability to expand the storage capacity.

### SUMMARY OF THE INVENTION

Systems and methods for portfolio expansion according to various aspects of the present invention may comprise an insert portion configured for coupling a portfolio expansion system to an internal pocket of one or more organization systems, a folder portion configured for storage and organization of various items, a pad attachment system for coupling various external components, and a storage space configured for storage and organization of various items. The portfolio expansion system may be adapted to substantially easily attach and detach to and from the organization systems.

### BRIEF DESCRIPTION OF THE DRAWINGS

A more complete understanding of the present invention may be derived by referring to the detailed description when considered in connection with the following illustrative figures. In the following figures, like reference numbers refer to elements and steps throughout the figures.

FIG. 1 representatively illustrates an inner right hand side of a prior art padfolio;

FIG. 2 representatively illustrates a rear perspective of a portfolio expansion system in accordance with an exemplary embodiment of the present invention;

FIG. 3 representatively illustrates a front perspective of the portfolio expansion system in accordance with an exemplary embodiment of the present invention; and

FIG. 4 representatively illustrates a bottom perspective of the portfolio expansion system in accordance with an exemplary embodiment of the present invention;

FIG. 5 representatively illustrates a retention mechanism of the portfolio expansion system in accordance with an exemplary embodiment of the present invention; and

FIG. 6 representatively illustrates an alternative retention mechanism of the portfolio expansion system in accordance with an exemplary embodiment of the present invention.

### DETAILED DESCRIPTION OF EXEMPLARY EMBODIMENTS

The present invention may be described in terms of functional block components and various processing steps. Such functional blocks may be realized by any number of components configured to perform the specified functions and achieve the various results. For example, the present invention may employ various types of fasteners, attachment systems or methods, materials, folders, straps, slits, inserts and the like, which may carry out a variety of functions. In addition, the present invention may be practiced in conjunction with any number of processes such as paper organization and protection, document storage, and securing papers, and the system described is merely one exemplary application for the invention. Further, the present invention may employ any number of conventional techniques for holding, organizing, storing, and protecting paper, providing storage, and attaching to a portfolio or other system for organizing paper.

Methods and apparatus for a portfolio expansion system according to various aspects of the present invention may operate in conjunction with any suitable portfolio, padfolio, folder, binder, notebook, or other organizational system organizing documents, papers, business cards, and the like. Various representative implementations of the present invention may be applied to any system for providing storage or organization to a padfolio, portfolio, or other transportable system for organizing documents.

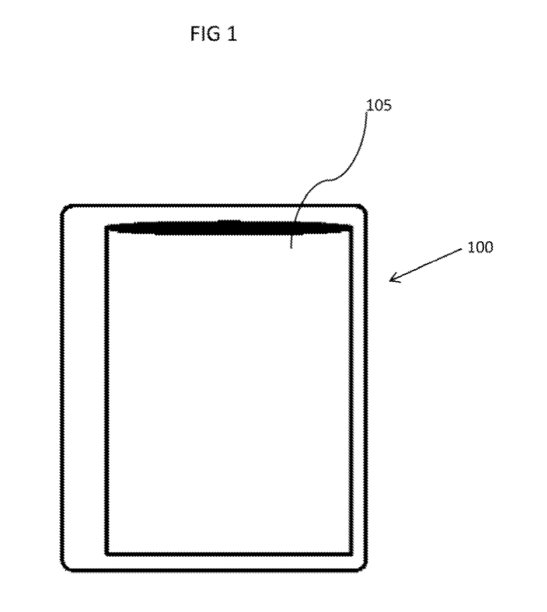

Referring to FIG. 1, an organization system 100 such as a padfolio commonly provides an internal surface for attaching a pad of paper, such as a sleeve or pocket 105. The pocket opening 105 may be oriented in any direction, and the pocket opening 105 may be located anywhere on or in the organization system 100. Typical pads of paper comprise a backing that provides support for the paper, such as a cardboard backing. The hacking may be inserted into the pocket 105 of the organization system 100 to impermanently attach the pad of paper to the organization system 100.

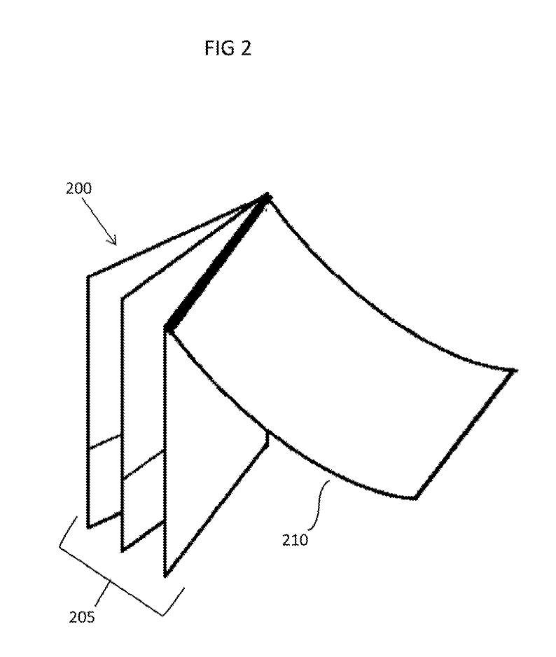

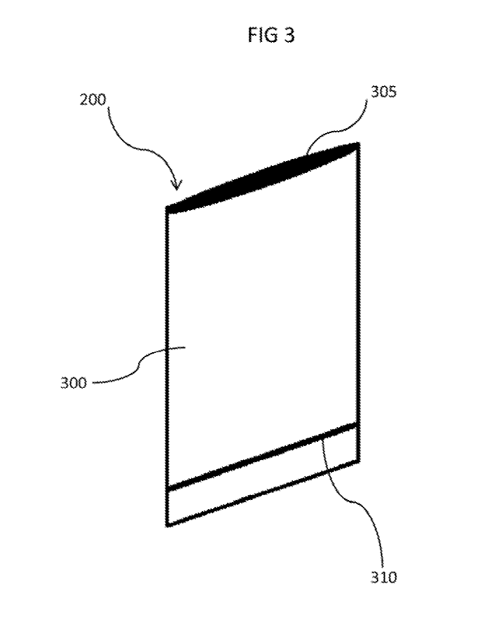

Referring now to FIGS. 2 and 3, in an exemplary embodiment of the present invention, a portfolio expansion system 200 may be configured to permanently or impermanently attach to the organization system 100. The portfolio expansion system 200 may be configured to hold any type of paper and may be configured to receive and hold a pad of paper while also providing easy access for a user to write on the pad of paper. For example, the portfolio expansion system 200 may comprise a folder portion 205, a pad attachment portion 300, and an attachment interface. The attachment interface may comprise an insert portion 210 configured to be inserted into the pocket 105 of the organization system 100. Alternatively, the attachment interface may disposed along at least a portion of the folder portion 205, such as along a rear section or panel of the folder portion 205. The attachment interface may be configured to permanently attach to the organization system 100, for example by being integrated into the organization system 100 during fabrication of the organization system 100. The folder portion 205 may be configured to hold any suitable items such as papers and/or documents of any type or size such as business cards, tabs, and/or labels, media storage devices such as CD-ROM and DVD discs, a tablet computer or other computing or non-computing device, and the like. The pad attachment portion 300 may be configured to receive a pad of paper such as a legal pad.

The various components of the portfolio expansion system 200 may be connected, joined, or attached together in any suitable manner. For example, the various components of the portfolio expansion system 200 may be manufactured separately and then attached together using tape, glue, heat, thread, staples, and the like. The portfolio expansion system 200 may comprise a single continuous material requiring no connection or attachment of the components, or various components of the portfolio expansion system 200 may comprise a single continuous material requiring no connection or attachment. For example, the entire portfolio expansion system 200 may be manufactured using a single mold. In one exemplary embodiment, the insert portion 210, folder portion 205, and pad attachment portion 300 may be attached together along a top edge. Alternatively, the folder portion 205 may be attached to the insert portion 210 and/or the pad attachment system 300 along a side edge such that the folder portion farms pages that may be turned like a book.

One or more components of the portfolio expansion system 200 may be configured to perform the functions of several components of the portfolio expansion system 200. For example, the folder portion 205 may be configured to perform the function of the insert portion 210, thus eliminating the need for the insert portion 210 in one exemplary embodiment.

Referring again to FIG. 2, the insert portion 210 may comprise any suitable system for attaching the portfolio expansion system 200 to the organization system 100. The insert portion 210 may comprise a flexible, resilient, rigid, elastic, and/or other material such as natural leather, synthetic leather, paper, cardboard, wood, composite, fabric, metal, and/or plastic. The insert portion 210 may comprise any shape suitable to being inserted at least partially within the pocket 105. For example, in one embodiment, the insert portion 210 may comprise a semi-rigid cardboard material shaped to fit at least partially within the pocket 105 of the organization system 100. In a second embodiment, the insert portion 210 may comprise relatively stiff plastic substantially shaped similar to the backing of a standard legal pad to facilitate the selective insertion and removal of the portfolio expansion system 200 to the organization system 100 using the pocket 105.

The insert portion 210 may be configured to attach the portfolio expansion system 200 to the organization system 100 by using a pocket or sleeve other than the pocket 105 commonly used to attach to a pad of paper. For example, padfolios frequently have additional pockets for organization such as vertical sleeves (not shown), and the insert portion 210 may be configured to fit at least partially within one of these other pockets. In another exemplary embodiment, the insert portion 210 may comprise a clip or in configured to attach the portfolio expansion system 200 to the organization system 100 without the need to fit within a pocket 105.

The folder portion 205 may comprise any suitable system for storing or organizing any size or type of paper, document, portable media device, memory storage device, and/or any objects such as business cards, portable communication devices, and the like. The folder portion 205 may comprise flexible, resilient, rigid, elastic, and/or other material suitable for holding and/or securing papers such as plastic, natural leather, synthetic leather, fabric, metal, and/or stiff paper. The folder portion 205 may comprise any suitable shape to hold paper such as one or more traditionally-shaped pocket and/or pronged file folder sections configured to hold loose papers or documents, section dividers, binders, and the like. In one exemplary embodiment, the multiple traditionally-shaped file folder sections may be configured with a common point or area for receiving papers. In another embodiment, the folder portion 205 may comprise multiple differently-shaped folder sections, pockets, and/or compartments. For example, the folder portion 205 may further comprise one or more receiving sections such as slits and/or small pockets configured to receive and secure objects such as a tablet computer or other computing or non-computing device, business cards, tabs, and/or labels.

Referring again to FIG. 3, the pad attachment portion 300 may comprise any suitable system for receiving a pad of paper. The pad attachment portion 300 may comprise flexible, resilient, lipid, elastic, and/or other material suitable for securing a pad of paper. In one embodiment, the pad attachment portion 300 may comprise an attachment pocket 305 and a strap 310. The strap 310 may be configured to prevent the pages of the pad of paper from coming loose or being folded.

The attachment pocket 305 may be configured to receive the backing material of the pad of paper. For example, the attachment pocket 305 may be shaped to allow the backing material to be selectively inserted and removed. In an alternative embodiment, the pad attachment portion 300 may comprise one or more bands (not shown) attached to a surface of the pad attachment portion 300 or the folder portion 205, wherein the bands are configured to secure the backing material to the surface. The bands may be made from any suitable material. In some embodiments, the pad attachment portion 300 may comprise a clip configured to attach to a pad of paper.

In an alternative embodiment, the pad attachment portion 300 may comprise a system for receiving objects such as a tablet computer or other computing or non-computing device. For example, the pad attachment portion 300 may comprise straps, slots, pockets, and/or clips comprising any suitable material and configured to secure a tablet computer to the portfolio expansion system 200.

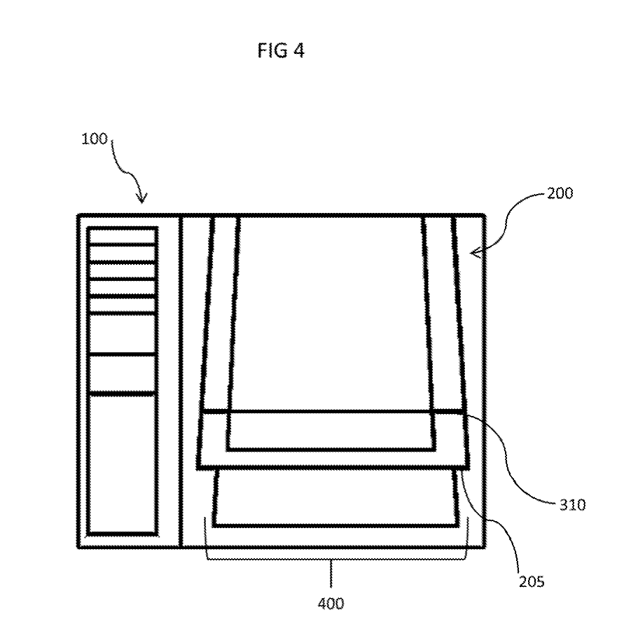

Referring to FIG. 4, the portfolio expansion system 200 may further be configured to define a storage space 400. The storage space 400 may comprise and suitable area or volume for receiving objects. In one exemplary embodiment, the storage space 400 way be defined between a first surface of the portfolio expansion system 200 and a second surface of the portfolio expansion system 200 or a first surface of the organization system 100.

The storage space 400 may further comprise a retention mechanism configured to control access to the storage space 400, wherein any paper or object placed in the storage space 400 may be secured within the storage space 400 by the retention mechanism. For example, in one embodiment, the retention mechanism may be configured to apply a pressure force to prevent objects placed within the storage space 400 from accidentally falling out. The pressure force may be generated at least partially applied by a weight of the folder portion 205, a pressure device, and/or one or more magnets.

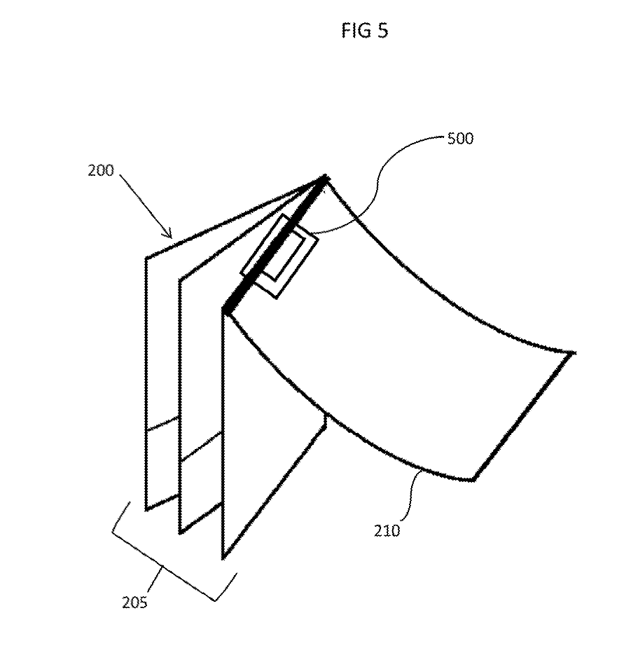

For example, in one embodiment, the weight of the folder portion 205 and/or the pad attachment portion 300 may be used to at least partially apply a pressure force against the storage space 400 in a direction of the organization system 100. Referring to FIG. 5, in a second embodiment, the portfolio expansion system 200 may comprise a pressure device 500 coupled to the folder portion 205 proximate an edge of the insert portion 210 and an edge of the folder portion 205. For example the pressure device 500 may comprise a spring coupled to the rear surface of the folder portion 205, wherein the spring is configured to cause the rear surface of the folder portion 205 to apply pressure to the front surface of the insert portion 210, or to apply pressure to the front surface of the pocket 105 when the insert portion 210 is inserted into the pocket 105.

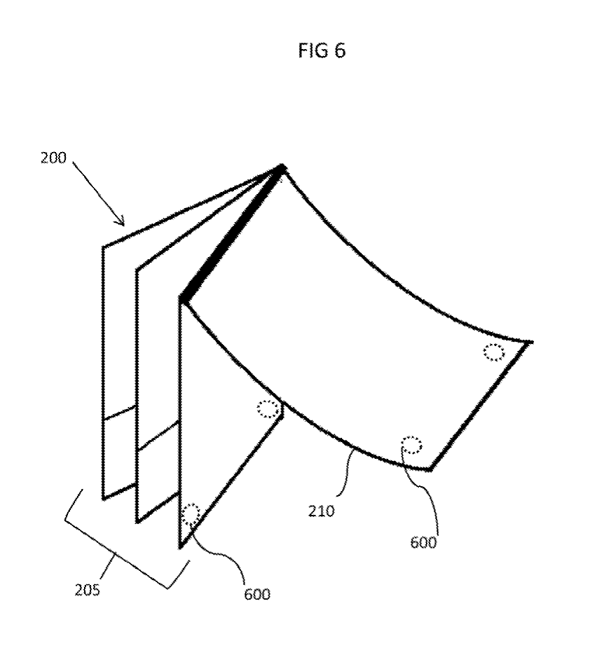

Referring now to FIG. 6, in yet another embodiment, one or more magnets 600 may be used to close the storage space 400. For example, one or more magnets 600 may be embedded, attached or otherwise adhered to a portion of the insert portion 210 and a rear section of the fielder portion 205, wherein the positioning of the magnets 600 on the insert portion 201 and the folder portion 205 cause the rear section of the folder portion 205 to be attracted towards the insert portion 210 to maintain a pressure to the front surface of the pocket 105 when the insert portion 210 is inserted into the pocket 105.

The storage space 400 may be defined by the portfolio expansion system 200 either alone or in combination with the organization system. In some embodiments, the storage space 400 may not require the use of an applied pressure to secure items placed within it, and may use any suitable system or method for securing items.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

These and other embodiments for methods of modular design may incorporate concepts, embodiments, and configurations as described with respect to embodiments of apparatus for completing a floor plan as described above. The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

The invention has been described with reference to specific exemplary embodiments. Various modifications and changes, however, may be made without departing from the scope of the present invention. The description and figures are to be regarded in an illustrative manner, rather than a restrictive one and all such modifications are intended to be included within the scope of the present invention. Accordingly, the scope of the invention should be determined by the generic embodiments described and their legal equivalents rather than by merely the specific examples described above. For example, the steps recited in any method or process embodiment may be executed in any order, unless otherwise expressly specified, and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

What is claimed is:

1. A portfolio expansion system for an organization system, comprising:
a folder portion comprising:
a front surface;
a rear surface; and
a plurality of folder sections disposed between the front and rear surfaces;
an attachment interface disposed along the rear surface of the folder portion and configured to selectively connect to the organization system; and
a selectively accessible storage space disposed between the attachment interface and the rear surface of the folder portion.

2. The portfolio expansion system of claim 1, wherein the front surface of the folder portion comprises a pad attachment portion configured to receive a backing of a pad of paper.

3. The portfolio expansion system of claim 1, wherein the plurality of folder sections includes a pad attachment portion configured to receive a backing of a pad of paper.

4. The portfolio expansion system of claim 1, wherein the plurality of folder sections are configured to connect to each other along at least one of a top edge and a side edge.

5. The portfolio expansion system of claim 1, wherein the attachment interface comprises an insert portion having a top edge and a bottom edge, wherein:
the top edge of the insert portion is coupled to a top edge of the rear surface of the folder portion; and
the bottom edge is adapted to at least partially fit within a pocket of the organization system.

6. The portfolio expansion system of claim 1, wherein the attachment interface comprises an insert portion having a first side edge and a second side edge, wherein:
the first side edge of the insert portion is coupled to a side edge of the rear surface of the folder portion; and
the second side edge is adapted to at least partially fit within a pocket of the organization system.

7. The portfolio expansion system of claim 1, further comprising a retention mechanism configured to control access to the selectively accessible storage space.

8. The portfolio expansion system of claim 7, wherein the retention mechanism comprises:
a first magnet coupled to a front surface of the insert portion; and
a second magnet coupled to the rear surface of the folder portion.

9. The portfolio expansion system of claim 7, wherein the retention mechanism comprises a pressure device coupled to an upper section of the folder portion, wherein the pressure device is configured to apply a pressure to the rear surface of the folder portion to close the selectively accessible storage space.

10. The portfolio expansion system of claim 1, wherein at least one of the plurality of folder sections comprises a receiving section configured to receive at least one of a computing device, business cards, tabs, and labels.

11. A portfolio expansion system for an organization system, comprising:
a folder portion comprising:
a front surface;
a rear surface; and
a plurality of folder sections disposed between the front and rear surfaces, wherein the front surface, the rear surface, and the plurality of folder sections are coupled together along a side edge; and
an insert portion coupled to the folder portion and configured to selectively connect to the organization system, wherein the insert portion comprises:
a top edge coupled to a top edge of the rear surface of the folder portion; and
a bottom edge adapted to at least partially fit within a pocket of the organization system.

12. A portfolio expansion system of claim 11, further comprising a selectively accessible storage space disposed between a front surface of the insert portion and the rear surface of the folder portion.

13. The portfolio expansion system of claim 12, further comprising a retention mechanism configured to control access to the storage space.

14. The portfolio expansion system of claim 13, wherein the retention mechanism comprises:
a first magnet coupled to the front surface of the insert portion; and
a second magnet coupled to the rear surface of the folder portion.

15. The portfolio expansion system of claim 13, wherein the retention mechanism comprises a pressure device coupled to an upper portion of the folder portion, wherein the pressure device is configured to apply a pressure to the rear surface of the folder portion to secure an object within the selectively accessible storage space.

16. The portfolio expansion system of claim 11, wherein the front surface of the folder portion comprises a pad attachment portion.

17. The portfolio expansion system of claim 16, wherein the pad attachment portion comprises:
an attachment pocket configured to receive a backing of a pad of paper; and
a strap connected to the folder portion configured to apply pressure to a plurality of papers attached to the backing of the pad of paper.

18. The portfolio expansion system of claim 16, wherein the pad attachment portion comprises a band connected to the folder portion configured to receive an object, wherein the band is configured to apply pressure to the object.

19. The portfolio expansion system of claim 11, wherein at least one of the plurality of folder sections comprises a receiving section configured to receive at least one of a computing device, business cards, tabs, and labels.
